(19) United States
(12) Patent Application Publication
(10) Pub. No.: US 2014/0294135 A1
(43) Pub. Date: Oct. 2, 2014

(54) POWDER OF AN ALLOY BASED ON URANIUM AND MOLYBDENUM IN GAMMA-METASTABLE PHASE, COMPOSITION OF POWDERS COMPRISING THIS POWDER, AND USES OF SAID POWDER AND COMPOSITION

(71) Applicants: Jerome Allenou, Lille (FR); Xavier Iltis, Pierrevert (FR); Francois Charollais, Villelaure (FR); Olivier Tougait, Rennes (FR); Mathieu Pasturel, Montreuil Sur Ille (FR); Stephanie Deputier, Rennes (FR)

(72) Inventors: Jerome Allenou, Lille (FR); Xavier Iltis, Pierrevert (FR); Francois Charollais, Villelaure (FR); Olivier Tougait, Rennes (FR); Mathieu Pasturel, Montreuil Sur Ille (FR); Stephanie Deputier, Rennes (FR)

(73) Assignee: COMMISSARIAT A L'ENRGIE ATOMIQUE ET AUX ENERGIES ALTERNATIVES, Paris (FR)

(21) Appl. No.: 14/126,523

(22) PCT Filed: Jun. 21, 2012
(86) PCT No.: PCT/EP12/61938

§ 371 Date: Feb. 25, 2014

(30) Foreign Application Priority Data
Jun. 23, 2011 (FR) 11 55551

(51) Int. Cl. G21C 21/02; G21C 3/42; C22C 43/00; B22F 1/00

(52) U.S. Cl. CPC G21C 21/02; B22F 1/0085; G21C 3/42; C22C 43/00
USPC 376/412; 419/9; 252/638; 428/402

(57) ABSTRACT

The invention relates to a powder of an alloy comprising uranium and molybdenum in γ-metastable phase, a composition of powders comprising this powder, and the uses of said alloy powder and of said composition of powders.

The alloy powder comprising uranium and molybdenum in γ-metastable phase according to the invention is formed of particles comprising a nucleus which consists of said alloy, and which is covered with a layer of alumina positioned in contact with this nucleus.

Applications: manufacture of nuclear fuel elements and, in particular, of fuel elements for experimental nuclear reactors; manufacture of targets intended for production of radioelements, which are useful in particular for medical imaging, such as technetium 99m.

### TECHNICAL FIELD

The present invention relates to a powder of an alloy based on uranium and molybdenum in γ-metastable phase and, in particular, to a powder of a U(Mo) binary alloy or of a U(MoX) ternary alloy, where X represents a chemical element other than uranium and molybdenum.

It also relates to a composition of powders comprising this alloy powder, blended with a powder comprising aluminium.

It also relates to the uses of said alloy powder and of said composition of powders.

Such an alloy powder and such a composition of powders may, indeed, be used for the manufacture of nuclear fuel elements and, in particular, fuel elements for experimental nuclear reactors, better known by the acronym MTR (Material Testing Reactor), such as the Jules Horowitz Reactor (JHR) of CEA Cadarache (France), the High Flux Reactor (HFR) of Institut Laue-Langevin of Grenoble (France), or again the high neutron flux reactor BR-2 in the Mol site (Belgium).

They may also be used for the manufacture of targets intended for the production of radioelements, which are useful in particular for medical imaging, such as for example technetium 99m.

The present invention also relates to a method of manufacturing a nuclear fuel element or a target for the production of a radioelement, and also to a nuclear fuel element and to a target for the production of a radioelement which is obtained by this method.

### STATE OF THE PRIOR ART

Until the 1950s, fuels dedicated to MTR essentially consisted of alloys of uranium and aluminium having a uranium 235 mass content of 93% for a specific charge of 1.2 g of uranium per cm³.

From 1977, at the instigation of the United States of America, a programme seeking to reduce risks of proliferation of nuclear weapons, and therefore to reduce the uranium enrichment rate of fuels dedicated to MTRs, was established internationally. This was the RERTR programme (Reduced Enrichment for Research and Test Reactor).

Since this time, the development of new uranium alloys able to be used as nuclear fuels in MTRs whilst having a uranium 235 mass content not exceeding 20% has led to many studies.

In particular, alloys based on uranium and silicon and alloys based on uranium and molybdenum have thus been studied.

This latter type of alloy is the one which has the most interesting properties, since it notably enables a specific charge of 8.5 g of uranium per cm³ of fuel to be reached, while this charge is only, at best, of 4.8 g of uranium per cm³ in the case of uranium silicides.

It was initially proposed to use alloys based on uranium and molybdenum in a form dispersed in an aluminium matrix, since aluminium has satisfactory neutron transparency, satisfactory water corrosion resistance, and satisfactory mechanical properties at temperatures close to 100° C.

However, it transpires that nuclear fuels consisting of an alloy based on uranium and molybdenum dispersed in an aluminium matrix have poor characteristics when subject to neutron irradiation, even at relatively moderate degrees of exposure. This is due in particular to the fact that, when subject to neutron irradiation, the alloy based on uranium and molybdenum interacts with the surrounding aluminium, which leads to the formation of aluminium-rich compounds such as UAl₄ and U₆Mo₄Al₄₃, which are detrimental in conditions of use (references [1] to [4]).

To address this problem, it was then proposed no longer to use an aluminium matrix, but a matrix consisting of an alloy of aluminium and silicon.

Indeed, it was shown that under the effect of the heat treatments which are applied to the nuclear fuel elements during their manufacture, the silicon present in the matrix in the form of precipitates diffuses towards the U(Mo) alloy particles, leading to the formation around these particles of a silicon-rich interaction layer.

This silicon-rich interaction layer has specific physical properties enabling it to remain stable when subject to neutron irradiation, and to reduce the diffusion of aluminium towards the alloy based on uranium and molybdenum and, hence, the U(Mo)-aluminium interactions.

In addition, when subject to neutron irradiation, the silicon precipitates which are positioned close to the particles of U(Mo) alloy help improve the stabilisation of the previously formed silicon-rich interaction layer and its protective role in relation to the diffusion of the aluminium.

The advantage of using a matrix consisting of an alloy of aluminium and silicon has been validated by tests when subject to neutron irradiation in an MTR reactor under moderate exposure conditions (references [5] to [8]).

However, many uncertainties surround the ability of such a matrix to improve the characteristics of nuclear fuels based on uranium and molybdenum if these fuels are subjected to higher levels of irradiation than those used in the abovementioned references [5] to [8], such as, for example, irradiation of a surface power density of 500 W/cm² with a uranium 235 consumption rate of over 50%.

The Inventors therefore set themselves the goal of finding a means enabling nuclear fuels based on uranium and molybdenum to be given very satisfactory characteristics when subject to neutron irradiation, even when these fuels are subjected to high levels of irradiation.

More specifically, they set themselves the goal of succeeding in reducing as far as possible the interactions likely to occur, when subject to neutron irradiation, between an alloy based on uranium and molybdenum and the aluminium of the matrix in which this alloy is dispersed, whether this matrix consists solely of aluminium or of an alloy of aluminium and silicon.

### DESCRIPTION OF THE INVENTION

These aims and others are accomplished by the invention, which proposes, firstly, a powder of an alloy comprising uranium and molybdenum in γ-metastable phase, which powder is formed of particles comprising a nucleus which consists of said alloy and which is covered with a layer of alumina positioned in contact with this nucleus.

Indeed, as part of their work the Inventors observed that, in a surprising manner, the effects of the deposition of a layer of alumina on particles of an alloy comprising uranium and molybdenum are as follows:
if the alloy particles are then dispersed in an aluminium matrix, to create on the surface of these particles a barrier to the diffusion of the aluminium subject to neutron irradiation; this barrier, depending on its thickness, enables the existence of U(Mo)-aluminium interactions, and therefore the formation of aluminium-rich compounds, which have detrimental characteristics when subject to neutron irradiation, to be greatly reduced or totally eliminated; and
if the alloy particles are then dispersed in a matrix of aluminium and silicon, to increase the speed at which the silicon is diffused towards these particles during heat treatments which are applied in the course of manufacture of the nuclear fuel elements, and by this means to cause the formation of an interaction layer which is more silicon-rich and thicker—and therefore more protective with regard to the diffusion of aluminium subject to neutron irradiation—than the layer obtained in the abovementioned references [5] to [8].

In both cases, these effects are such that they lead to a reduction of the volume of interaction between the uraniferous fissile particles and the aluminium matrix within the nuclear fuel, an improved solubilisation and an improved retention of the fission gases subject to neutron irradiation, a reduction of the swelling of the nuclear fuels and, ultimately, greatly improved properties of these fuels, including when they are subjected to high levels of irradiation.

In accordance with the invention, the layer of alumina covering the nucleus of the alloy particles is advantageously at least 50 nm thick, and its thickness preferably ranges from 50 nm to 3 μm (for example, 50 nm, 100 nm, 150 nm, 200 nm, 250 nm, 300 nm, 350 nm, 400 nm, 450 nm, 500 nm, 550 nm, etc.) and, more preferably, from 100 nm to 1000 nm.

This layer of alumina may be deposited by any technique which enables metal particles to be covered by a thin layer of a metal or metal oxide, and notably by:
the technique of chemical vapour deposition, more commonly known as CVD, in all its forms: conventional thermal CVD, metal-organic CVD (MOCVD), atmospheric pressure CVD (APCVD), low-pressure CVD (LPCVD), ultra-high vacuum CVD (UHVCVD), aerosol-assisted CVD (AACVD), direct liquid injection CVD (DLICVD), rapid thermal CVD (RTCVD), initiated CVD (i-CVD), atomic layer CVD (ALCVD), hot wire CVD (HWCVD), plasma-enhanced CVD (PECVD), remote plasma-enhanced CVD (RPECVD), microwave plasma CVD (MWPCVD), etc;
the technique of physical vapour deposition, more commonly known as PVD, in all its forms: cathodic sputtering PVD, vacuum evaporation PVD, ion beam sputtering PVD, arc PVD, for example cathodic arc PVD, pulsed laser deposition (PLD), etc.; and
the hybrid physical-chemical vapour deposition technique (HPCVD);
the technique of deposition by mechanical action, which consists in causing a strong adhesion of sub-micron particles (coating particles) on the surface of micrometric particles (substrate particles), in all its forms: mechanofusion, the “hybridizer” process as described in reference [9], coating by magnetically assisted collision, rotary fluidised bed, theta grinder, high shear mixer, modulated pressure pelletiser.

In accordance with the invention, the alloy powder is preferably formed from particles the dimensions of which, as determined by diffraction and laser diffusion, range from 1 to 300 μm and, more preferably, from 20 to 100 μm.

The alloy comprising uranium and molybdenum, which forms the nucleus of the particles of this powder, is preferably:
either a U(Mo) binary alloy, i.e. an alloy consisting solely of uranium and molybdenum, in which case molybdenum preferentially represents 5 to 15% by mass and, more preferentially, 7 to 10% by mass of this alloy;
or a U(MoX) ternary alloy wherein X represents a chemical element other than uranium and molybdenum, which is able to improve still further the characteristics of the nuclear fuels subject to neutron irradiation, in which case molybdenum preferentially represents 5 to 15% by mass and, more preferentially, 7 to 10% by mass of this alloy, while X, which may notably be a metal such as titanium, zirconium, chromium, niobium, platinum, tin, bismuth, ruthenium or palladium, or a semiconductor such as silicon, typically represents at most 6% by mass of the alloy and, more preferentially, at most 4% by mass of said alloy.

In accordance with the invention, this alloy may be prepared by any known method enabling an uranium and molybdenum alloy in γ-metastable phase to be manufactured in the form of a powder and, notably, by methods known as “melting-atomisation” as described in references [10] to [12], methods known as “mechanical melting-fragmentation”, methods known as “chemical melting-fragmentation” and any method derived from the foregoing.

Another object of the invention is a composition of powders which comprises a powder of an alloy comprising uranium and molybdenum in γ-metastable phase, as described above, blended with a powder comprising aluminium, where the aluminium mass content of this powder is at least equal to 80%.

In this composition of powders, the powder comprising aluminium is preferentially an aluminium powder (i.e. a powder which contains only aluminium), or alternatively a powder of an alloy comprising aluminium and silicon, for example a powder of a binary alloy Al(Si), in which case the aluminium typically represents 88 to 98% by mass and, more preferentially, 92 to 96% by mass of this alloy, while the silicon typically represents 2 to 12% by mass and, more preferentially, 4 to 8% by mass of this alloy.

In all cases, the alloy powder comprising uranium and molybdenum in γ-metastable phase preferably represents 65 to 90% by mass and, more preferably, 80 to 90% by mass of the powder composition.

Another object of the invention is the use of a powder of an alloy comprising uranium and molybdenum in γ-metastable phase, as previously described, or of a composition of powders as previously described, for the manufacture of nuclear fuel elements and, notably, of fuel elements for experimental nuclear reactors such as the Jules Horowitz Reactor (JHR) of CEA Cadarache (France), the High Flux Reactor (HFR) of Institut Laue-Langevin of Grenoble (France), or again the high neutron flux reactor BR-2 in the Mol site (Belgium).

Another of its object is the use of a powder of an alloy comprising uranium and molybdenum in γ-metastable phase as previously described, or of a composition of powders as previously described, for manufacturing targets intended for the production of radioelements, which are useful in particular for medical imaging, such as, for example, technetium 99m.

Another object of the invention is a method for manufacturing a nuclear fuel element or of a target for the production of a radioelement, which comprises filling a sheath with a composition of powders as previously described and applying at least one heat treatment to the assembly so obtained.

In a first preferred embodiment of this method, the powder comprising aluminium, which is present in the powder composition, is an aluminium powder. In this case, the nuclear fuel element or the target for the production of a radioelement, which is obtained by this method, comprises a sheath in which a core is held, and this core is formed from an aluminium matrix within which particles are dispersed, these particles comprising a nucleus which consists of an alloy comprising uranium and molybdenum in γ-metastable phase and which is covered by a layer of alumina positioned in contact with this nucleus.

In another embodiment of the method according to the invention, the powder comprising aluminium, which is present in the powder composition, is a powder of an alloy comprising aluminium and silicon, for example a powder of an Al(Si) binary alloy. In which case, the nuclear fuel element or the target for the production of a radioelement, which is obtained by this method, comprises a sheath in which a core is held, and this core is formed from a matrix comprising aluminium and silicon within which particles are dispersed, these particles comprising a nucleus which consists of an alloy comprising uranium and molybdenum in γ-metastable phase and which is covered by a layer comprising uranium, molybdenum, aluminium and silicon, positioned in contact with this nucleus, the atomic silicon content of which is at least equal to 50% at the contact with said nucleus, the layer being itself covered with a layer of alumina.

The nuclear fuel element or the target for production of a radioelement advantageously takes the form, in all cases, of a plate or a rod.

Other characteristics and advantages of the invention will become apparent from the additional description which follows, which relates to examples of deposition of a layer of alumina on solid substrates of a binary alloy of uranium and molybdenum, and of demonstration of the chemical reactivity of the substrates obtained in this manner in the presence of aluminium and of an alloy of aluminium and silicon.

It is self-evident that these examples are given only to illustrate the object of the invention, and do not in any way constitute a limitation of this object.

It should be noted that the examples which are reported below have been achieved by using a U(Mo) binary alloy in the form of solid substrates, and not in the form of a powder, only for reasons of safety for the experimenters, since handling of powders based on uranium is more delicate and subject to greater risk than that of solid substrates.

However, this has no effect on the validity of the experimental results obtained.

### BRIEF DESCRIPTION OF THE FIGURES

FIGS. 1A, 1B and 1C represent images, taken with a scanning electron microscope (SEM) in secondary electron mode, at a magnification of 50,000, showing the thickness of layers of alumina having been deposited on solid substrates made of an alloy of uranium and molybdenum with 8% molybdenum by mass, in γ-metastable phase (called below “γ-U(8Mo) alloy”); FIG. 1A corresponds to the deposition of a layer of alumina which is approximately 50 nm thick; FIG. 1B corresponds to the deposition of a layer of alumina which is approximately 100 nm thick; and FIG. 1C corresponds to the deposition of a layer of alumina which is approximately 400 nm thick.

FIGS. 2A, 2B and 2C represent images taken with an SEM in secondary electron mode, at a magnification of 500, showing the surface condition of the layers of alumina shown respectively in FIGS. 1A, 1B and 1C.

FIG. 3 represents schematically the way in which a solid substrate made of a γ-U(8Mo) alloy, having been covered with a layer of alumina, is embedded in a part made of aluminium or of an alloy of aluminium and silicon with 7% mass of silicon (called below an “Al(7Si) alloy”), with a view to testing the chemical reactivity of the γ-U(8Mo) alloy in the presence of aluminium and of an alloy of aluminium and silicon, in a diffusion pair activated by a heat treatment.

FIG. 4 represents the TTT graph (Temperature, Time, Transformation) of a γ-U(8Mo) alloy, enabling the time in hours at the end of which the γ phase of this alloy is destabilised to be determined, for a given temperature in degrees Celsius.

FIGS. 5A, 5B, 5C represent images taken with an SEM in backscattered electron mode, at a magnification of 200, showing the γ-U(8Mo)/Al interface of diffusion pairs consisting of a solid substrate made of a γ-U(8Mo) alloy, covered with a layer of alumina and of aluminium; FIG. 5A corresponds to a diffusion pair in which the layer of alumina is approximately 50 nm thick; FIG. 5B corresponds to a diffusion layer in which the layer of alumina is approximately 100 nm thick, while FIG. 5C corresponds to a diffusion pair in which the layer of alumina is 400 nm thick; as a reference, FIG. 5D represents an image taken with an SEM under the same conditions, and showing the γ-U(8Mo)/Al interface of a diffusion pair consisting of a solid substrate and a γ-U(8Mo) alloy which has not been covered with a layer of alumina, and of aluminium.

FIG. 6A represents an image taken with an SEM in backscattered electron mode, at a magnification of 1,000, showing the γ-U(8Mo)/Al interface of a diffusion pair consisting of a solid substrate made of a γ-U(8Mo) alloy, covered with a layer of alumina which is approximately 50 nm thick, and of aluminium, while FIGS. 6B and 6C represent the X mappings, respectively of oxygen and of aluminium, which were obtained by SEM coupled with energy dispersive spectroscopy (SEM-EDS) at this interface.

FIG. 7A represents an image taken with an SEM in backscattered electron mode, at a magnification of 1,000, showing the γ-U(Mo)/Al interface of a diffusion pair consisting of a solid substrate made of a γ-U(8Mo) alloy, covered with a layer of alumina which is approximately 400 nm thick, and of aluminium, while FIGS. 7B and 7C represent the X mappings, respectively of oxygen and of aluminium, which were obtained by SEM-EDS at this interface.

FIG. 8A represents an image taken with an SEM in backscattered electrons mode, at a magnification of 1,500, showing the γ-U(8Mo)/Al(7Si) interface of a diffusion pair consisting of a solid substrate made of a γ-U(8Mo) alloy, covered with a layer of alumina approximately 400 nm thick, and of an Al(7Si) alloy, together with the X mapping of the silicon having been obtained by SEM-EDS at this interface; as a reference, FIG. 8B represents an image taken with an SEM under the same conditions showing the γ-U(8Mo)/Al(7Si) interface of a diffusion pair consisting of a solid substrate made of a γ-U(8Mo) alloy not having been covered with a layer of alumina, and of an Al(7Si) alloy, together with the X mapping of the silicon having been obtained by SEM-EDS at this interface.

FIG. 9A represents an image taken with an SEM in backscattered electrons mode, at a magnification of 2000, showing the γ-U(8Mo)/Al(7Si) interface of a diffusion pair consisting of a solid substrate made of a γ-U(8Mo) alloy, covered with a layer of alumina which is approximately 400 nm thick, and of an Al(7Si) alloy, while FIGS. 9B and 9C represent the X mappings, respectively of oxygen and of aluminium, which were produced by SEM-EDS at this interface.

### DETAILED DESCRIPTION OF PARTICULAR EMBODIMENTS

### Example 1

### Deposition of a Layer of Alumina on Solid Substrates Made of a γ-U(8Mo) Alloy

A layer of alumina which is approximately 50, 100 or 400 nm thick is deposited on substrates which measure 4±0.5 mm in length, 4±0.5 mm in width and 1±0.5 mm in thickness, and which consist of an alloy of uranium and molybdenum with 8% by mass of molybdenum in γ-metastable phase (γ-U(8Mo)), by the technique of Pulsed Laser Deposition.

Since this technique is well-known, it is recalled simply that it consists in bombarding, in a vacuum enclosure, a target consisting of the material to be deposited with a pulsed laser beam. When the laser power density is sufficiently high, a certain quantity of material is ejected from the target, perpendicular to its surface, and is deposited on a substrate, which may be heated, positioned opposite the target.

In the present case, the target used is an alumina target, the pressure in the enclosure is of the order of 10⁻⁶ mbar (high vacuum), and the substrates are not heated during the pulsed laser deposition operations.

The surface of the substrates is micron polished beforehand and cleaned by ultrasounds in a succession of baths consisting in the first case of demineralised water, in the second of ethanol, and in the third of cyclohexane, the time spent in the ultrasound baths being approximately 30 seconds for each bath.

The operational parameters used for the pulsed laser deposition operations are shown in the table below for each thickness of deposited layer of alumina.

| | | | |
|---|---|---|---|
| Thickness of the layer of alumina (nm) | ≈50 | ≈100 | ≈400 |
| Power of the laser (mJ) | 200 | 200 | 200 |
| Frequency of the laser (Hz) | 2 | 2 | 3 |
| Deposition time (min) | 15 | 30 | 60 |

After the pulsed laser deposition operations, each substrate is subjected to analyses by scanning electron microscopy (SEM), in secondary electron mode, with a view:
firstly, to measuring the thickness of the layer of alumina deposited on this substrate, this measurement being made by fracturing this layer and observation of its transverse section; and
secondly, to assessing the quality of the alumina deposit and, in particular, the possible presence, on the surface of the layer of alumina, of flaws visible at the micrometric scale.

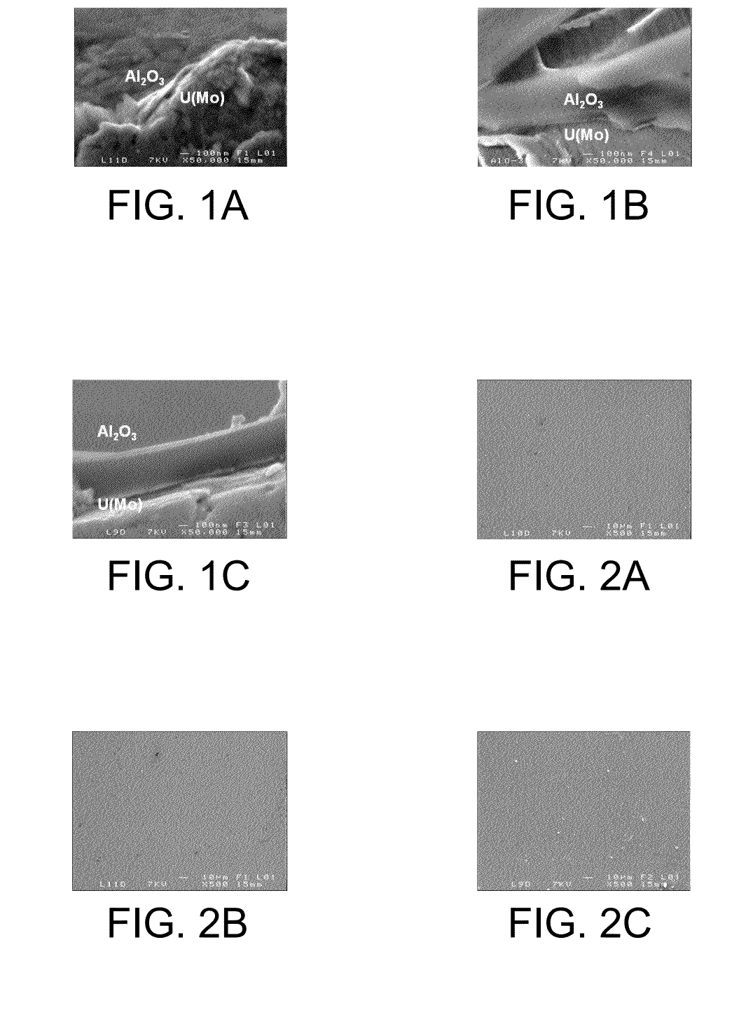

The results of the thickness measurements are illustrated in FIGS. 1A, 1B and 1C, while the results of the observations of the surface conditions are illustrated in FIGS. 2A, 2B and 2C.

As may be seen in these figures, the layers of alumina do indeed have the expected thickness (i.e. approximately 50 nm in FIG. 1A, approximately 100 nm in FIG. 1B, and approximately 400 nm in FIG. 1C), and in all cases have a uniform surface condition, free of flaws at the micrometric scale.

### Example 2

### Chemical Reactivity of Solid Substrates Made of a γ-U(8Mo) Alloy, Covered with a Layer of Alumina, in the Presence of Aluminium or of an Al(Ni) Alloy

The chemical reactivity of substrates made of γ-U(8Mo) alloy having been covered with a layer of alumina, as described in example 1 above, is tested in the presence of aluminium, firstly, and of an alloy of aluminium and silicon with 7% by mass of silicon (Al(7Si)), secondly, in a diffusion pair activated by a heat treatment.

This experimental technique is justified and used to develop technological solutions for current dispersed fuels (references [13] and [14]).

The conduct of diffusion pair testing means that the surface condition of the parts made of aluminium or of Al(7Si) alloy intended to be used in these tests must be prepared. After micron polishing, one of the end faces of these parts, which take the form of bars 6±0.1 mm in diameter and 6 mm in height, is therefore cleaned in the same way as that described in example 1 above for cleaning the surface of the substrates made of γ-U(8Mo) alloy.

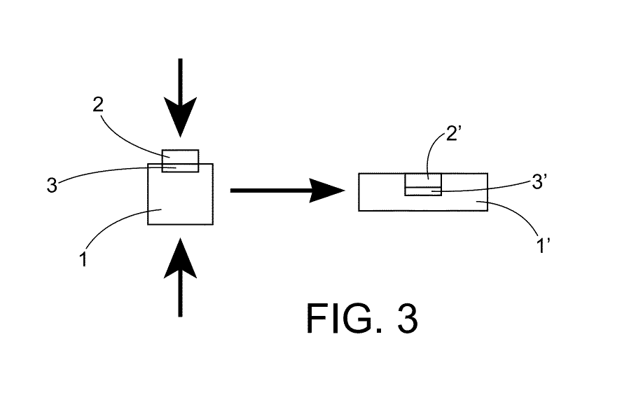

Each substrate made of γ-U(8Mo) alloy covered with a layer of alumina is then deposited on the end face prepared in this manner of a part made of aluminium or of Al(7Si) alloy and embedded in this part according to the diagram represented in FIG. 3, in which:
references 1 and 1′ correspond to the part made of aluminium or of Al(7Si) alloy, respectively before and after embedding a substrate made of γ-U(8Mo) alloy;
references 2 and 2′ correspond to the substrate made of γ-U(8Mo) alloy, respectively before and after embedding this substrate; while
references 3 and 3′ correspond to the layer of alumina covering this substrate, respectively before and after embedding said substrate.

By this means, a compact is obtained measuring approximately 9 mm in diameter by approximately 3 mm in height.

This compact is then packaged in a tantalum sheet 30 μm thick, and then inserted between the jaws of a clamping device made of stainless steel, the tantalum sheet then being intended to prevent any reaction between the materials of the compact and the stainless steel of the clamping device. This device is then tightened to a torque of 4±0.04 N.m using a torque wrench and a torque socket no 6.

The compact/clamping device assembly is then positioned in a tube furnace with a reducing atmosphere consisting of argon and hydrogen in a 95/5 volume ratio.

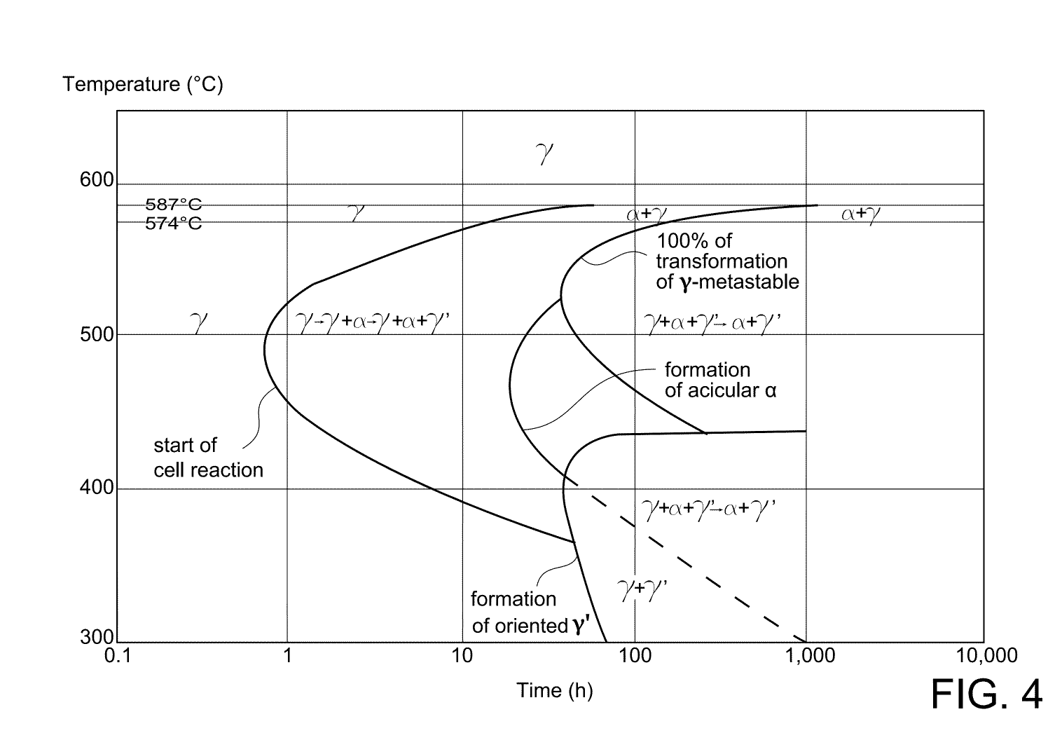

The temperature and the annealing time are determined on the basis of the TTT diagram (Temperature, Time, Transformation) shown in FIG. 4, such that the γ-U(8Mo) alloy does not undergo eutectoid decomposition.

In diffusion pair chemical reactivity tests, the annealing temperature and time are also chosen such that these parameters are sufficiently high to activate the diffusion between the materials constituting the diffusion pair.

An annealing temperature and annealing times satisfying both these conditions are, in the present case, a temperature of 600° C. and times ranging from 0.5 to 4 hours.

As a reference, the chemical reactivity tests undertaken with the substrates made of γ-U(8Mo) alloy covered with an aluminium layer are also carried out, under strictly identical experimental conditions, with substrates which are also made of γ-U(8Mo) alloy, but on which no layer of alumina has been deposited.

In all cases, after the annealing the diffusion pairs are subjected to analyses by SEM, in backscattered electrons mode, coupled with analyses by Energy Dispersive Spectroscopy, better known by the acronym EDS, with a view:
firstly, to determining whether an interaction zone has been formed at the γ-U(8Mo)/Al or γ-U(8Mo)/Al(7Si) interfaces and, if so, to measuring the thickness of this interaction zone;
secondly, to mapping the oxygen and aluminium present at the γ-U(8Mo)/Al or γ-U(8Mo)/Al(7Si) interfaces of the diffusion pairs, the substrate made of γ-U(8Mo) alloy of which has been covered with a layer of alumina, so as to localise this layer of alumina; and
lastly, to mapping the silicon present at the γ-U(8Mo)/Al(7Si) interfaces of the diffusion pairs comprising an Al(7Si) alloy.

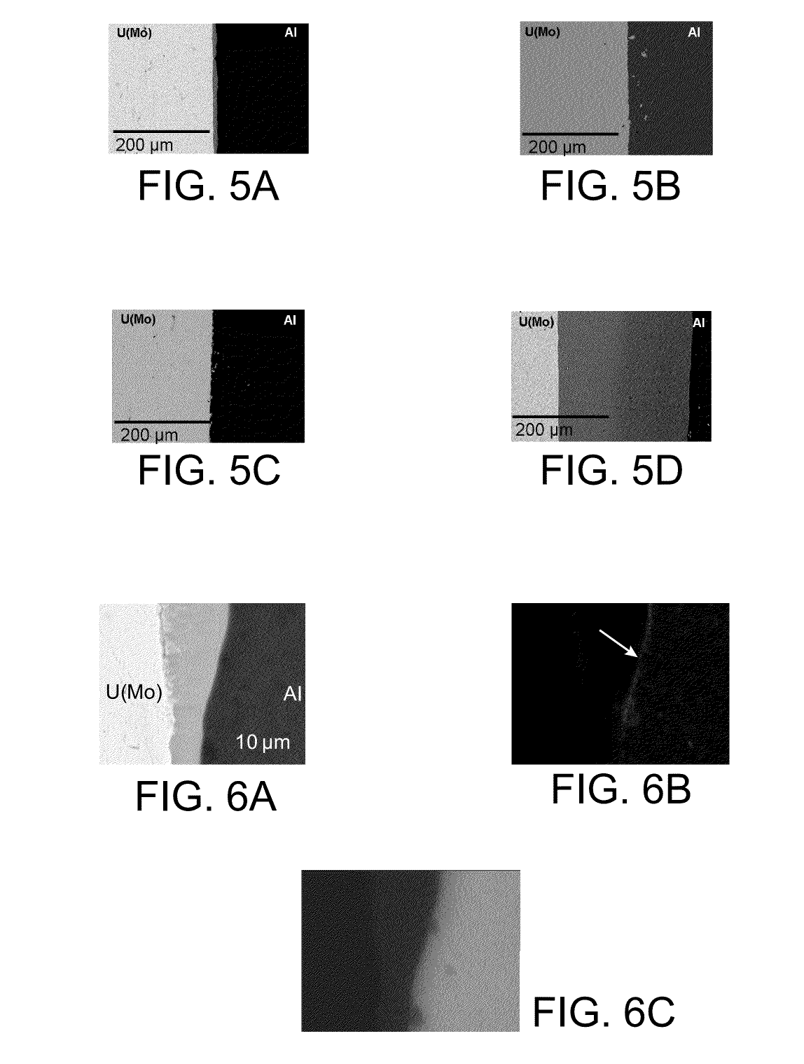

The results of these analyses are shown in FIGS. 5A to 9C, which correspond to the following diffusion pairs:

FIG. 5A: γ-U(8Mo)/Al₂O₃/Al where Al₂O₃≈50 nm;

FIG. 5B: γ-U(8Mo)/Al₂O₃/Al where Al₂O₃≈100 nm;

FIG. 5C: γ-U(8Mo)/Al₂O₃/Al where Al₂O₃≈400 nm;

FIG. 5D: γ-U(8Mo)/Al, used as a reference for the previous three pairs;

FIGS. 6A, 6B and 6C: γ-U(8Mo)/Al₂O₃/Al where Al₂O₃≈50 nm;

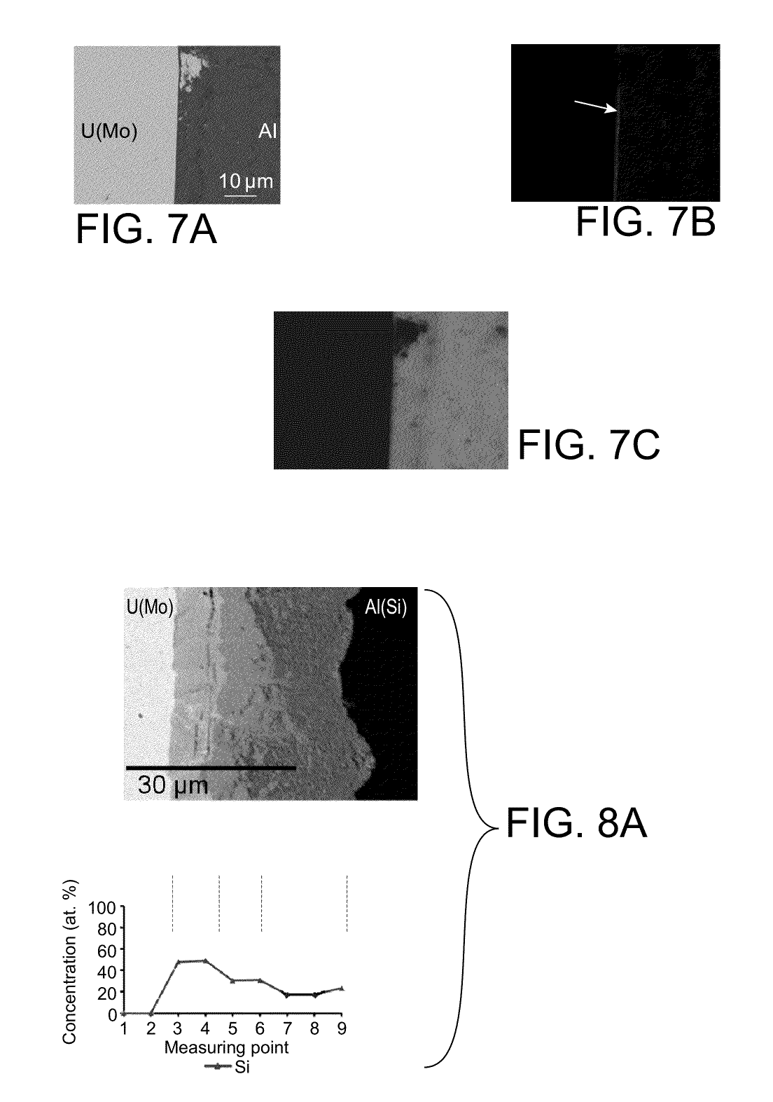

FIGS. 7A, 7B and 7C: γ-U(8Mo)/Al₂O₃/Al where Al₂O₃≈400 nm;

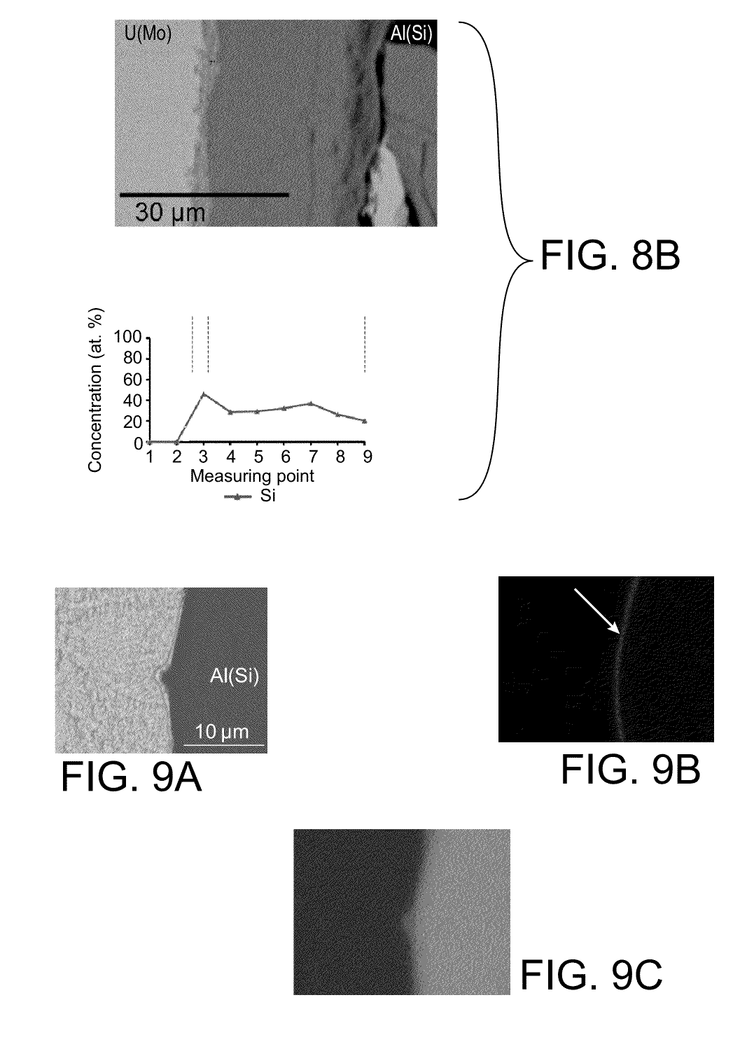

FIG. 8A: γ-U(8Mo)/Al₂O₃/Al(7Si) where Al₂O₃≈400 nm;

FIG. 8B: γ-U(8Mo)/Al(7Si), used as a reference for the diffusion pair of FIG. 8A; and

FIGS. 9A, 9B and 9C: γ-U(8Mo)/Al₂O₃/Al(7Si) where Al₂O₃≈400 nm.

All these diffusion pairs were treated for 4 hours at 600° C., i.e. a temperature higher than that which may be applied to nuclear fuel elements, either during their manufacture or during their irradiation in an MTR reactor.

As shown in FIGS. 5A to 5D, 6A and 7A, an interaction zone is observed at the U(8Mo)/Al interface in the γ-U(8Mo)/Al₂O₃/Al diffusion pair where Al₂O₃≈50 nm (FIGS. 5A and 6A) and also in the γ-U(8Mo)/Al reference diffusion pair (FIG. 5D). Conversely, this interaction zone is absent in the γ-U(8Mo)/Al₂O₃/Al diffusion pairs where Al₂O₃≈100 nm (FIG. 5B) and Al₂O₃≈400 nm (FIGS. 5C and 7A).

In addition, the interaction zone is only 20 μm thick in the γ-U(8Mo)/Al₂O₃/Al diffusion pair where Al₂O₃≈50 nm (FIGS. 5A and 6A), whereas it is 275 μm thick in the γ-U(8Mo)/Al reference diffusion pair (FIG. 5D).

The presence of a layer of alumina therefore enables the thickness of the interaction zone formed to be reduced, under the effect of a heat treatment, between the γ-U(8Mo) alloy and the aluminium matrix in which this alloy is dispersed, and even enables this interaction zone to be eliminated completely when said layer of alumina is of the order of 100 nm thick or thicker.

In addition, as is shown in FIGS. 6B and 7B, the X mappings of oxygen and aluminium demonstrate the existence of a fine layer of alumina, which is marked by an arrow in FIGS. 6B and 7B, and which is positioned on the side of the aluminium in the γ-U(8Mo)/Al₂O₃/Al diffusion pair where Al₂O₃≈50 nm, and at the γ-U(8Mo)/aluminium interface in the γ-U(8Mo)/Al₂O₃/Al diffusion pair where Al₂O₃≈400 nm.

If reference is at present made to FIGS. 8A, 8B and 9A, it is observed that the thickness of the interaction zone which is formed, under the effect of a heat treatment, between the γ-U(8Mo) alloy and the Al(7Si) alloy matrix in which the γ-U(8Mo) alloy is dispersed differs only slightly if the particles of γ-U(8Mo) alloy are or are not covered with a layer of alumina (30-35 μm compared to 30 μm).

Similarly, it is observed that a particular stratification into layers of different degrees of silicon enrichment develops in this interaction zone, whether or not the γ-U(8Mo) alloy particles are covered with a layer of alumina.

Conversely, the presence of a layer with silicon enrichment at approximately 51%, which is of the order of 10 μm thick, is noted in the interaction zone of the γ-U(8Mo)/Al₂O₃/Al(7Si) diffusion pair where Al₂O₃≈400 nm.

This layer is therefore richer in silicon and three times thicker than the most silicon-rich layer which the γ-U(8Mo)/Al(7Si) reference diffusion layer contains, the atomic silicon enrichment of which does not exceed 46% over a thickness of 2 to 3 μm.

Finally, as shown in FIGS. 9B and 9C, the X mappings of the oxygen and aluminium reveal the existence of a fine layer of alumina (shown by an arrow in FIG. 9B) on the side of the Al(7Si) alloy in the γ-U(8Mo)/Al₂O₃/Al(7Si) diffusion pair where Al₂O₃≈400 nm.

In the example which just described, the chemical reactivity of the substrates made of γ-U(8Mo) alloy was tested by applying to the different diffusion pairs a temperature higher than those which may be applied to the nuclear fuel elements during their manufacture and during their irradiation in an MTR reactor. It is therefore predictable that the benefits procured by the presence of a layer of alumina on the substrates made of γ-U(8Mo) alloy, as observed in this example, will also be obtained during industrial application of the invention, but for layers of alumina which are appreciably smaller than those used in said example.

### CITED REFERENCES

[1] M. K. Meyer et al., J. Nuclear Mater. 304 (2002) 221
[2] G. L. Hofman et al., RERTR 2003, Chicago, USA
[3] A. Leenaers et al., J. Nuclear Mater. 335 (2004) 39
[4] F. Huet et al. in: The Proceedings of the 9^{th} International Topical Meeting on Research Reactor Fuel Management (RRFM) 2005, Budapest, Hungary
[5] A. Leenaers et al. in: The Proceedings of the 12^{th} International Topical Meeting on Research Reactor Fuel Management (RRFM) 2008, Hamburg, Germany
[6] D. D. Keyser et al. in: The Proceedings of the 13^{th} International Topical Meeting on Research Reactor Fuel Management (RRFM) 2009, Vienna, Austria
[7] Y. S. Kim et al. in: The Proceedings of the 13^{th} International Topical Meeting on Research Reactor Fuel Management (RRFM) 2009, Vienna, Austria
[8] M. Ripert et al. in: The Proceedings of the 15^{th} International Topical Meeting on Research Reactor Fuel Management (RRFM) 2011, Rome, Italy
[9] French patent application no 2 777 688
[10] U.S. Pat. No. 4,915,987
[11] U.S. Pat. No. 5,978,432
[12] Japanese patent application no 55-054508
[13] J. Allenou et al., J. Nuclear Mater. 399 (2010) 189
[14] M. Mirandou et al., J. Nuclear Mater. 384 (2009) 268

1.-22. (canceled)

23. A powder of an alloy comprising uranium and molybdenum, in γ-metastable phase, which is formed of particles comprising a nucleus, the nucleus consisting of the alloy and being covered with a layer of alumina positioned in contact with the nucleus.

24. The powder of claim 23, wherein the layer of alumina is at least 50 nm thick.

25. The powder of claim 24, wherein the layer of alumina is from 50 nm to 3 μm thick.

26. The powder of claim 23, wherein the particles have dimensions ranging from 1 μm to 300 μm.

27. The powder of claim 23, wherein the alloy is a binary alloy of uranium and molybdenum.

28. The powder of claim 27, wherein the alloy has a mass molybdenum content ranging from 5 to 15%.

29. The powder of claim 23, wherein the alloy is a ternary alloy of uranium, molybdenum and a chemical element X other than uranium and molybdenum.

30. The powder of claim 29, wherein the chemical element X is a metal or a semiconductor.

31. The powder of claim 29, wherein the alloy has a mass molybdenum content ranging from 5 to 15% and a mass content of the chemical element X at most equal to 6%.

32. A composition of powders, which comprises a first powder of an alloy comprising uranium and molybdenum, in γ-metastable phase, which is formed of particles comprising a nucleus, the nucleus consisting of the alloy and being covered with a layer of alumina positioned in contact with the nucleus, and a second powder comprising aluminium, which is blended with the first powder.

33. The composition of powders of claim 32, wherein the second powder has a mass aluminium content at least equal to 80%.

34. The composition of powders of claim 32, wherein the second powder is an aluminium powder or a powder of an alloy comprising aluminium and silicon.

35. The composition of powders of claim 34, wherein the alloy comprising aluminium and silicon has a mass aluminium content ranging from 88 to 98% and a mass silicon content ranging from 2 to 12%.

36. The composition of powders of claim 32, wherein the first powder represents 65 to 90% by mass of the composition of powders.

37. A method for manufacturing a nuclear fuel element or of a target for the production of a radioelement, which comprises
filling a sheath with a composition of powders comprising a first powder of an alloy comprising uranium and molybdenum, in γ-metastable phase, the first powder being formed of particles comprising a nucleus, the nucleus consisting of the alloy and being covered with a layer of alumina positioned in contact with the nucleus, and a second powder comprising aluminium, which is blended with the first powder, and
applying at least one heat treatment to the sheath so filled.

38. The method of claim 37, wherein the second powder is an aluminium powder.

39. The method of claim 37, wherein the second powder is a powder of an alloy comprising aluminium and silicon.

40. A nuclear fuel element or target for producing a radioelement, which is obtained by a method comprising
filling a sheath with a composition of powders comprising a first powder of an alloy comprising uranium and molybdenum, in γ-metastable phase, the first powder being formed of particles comprising a nucleus, the nucleus consisting of the alloy and being covered with a layer of alumina positioned in contact with the nucleus, and a second powder, the second powder being an aluminium and being blended with the first powder, and
applying at least one heat treatment to the sheath so filled;
the element or target comprising a sheath in which a core is held, the core being formed from an aluminium matrix within which particles are dispersed, the particles comprising a nucleus, the nucleus consisting of an alloy comprising uranium and molybdenum in γ-metastable phase and being covered by an alumina layer, the layer being positioned in contact with this nucleus.

41. A nuclear fuel element or target for producing a radioelement, which is obtained by a method comprising
filling a sheath with a composition of powders comprising a first powder of an alloy comprising uranium and molybdenum, in γ-metastable phase, the first powder being formed of particles comprising a nucleus, the nucleus consisting of the alloy and being covered with a layer of alumina positioned in contact with the nucleus, and a second powder, the second powder being a powder of an alloy comprising aluminium and silicon and being blended with the first powder, and
applying at least one heat treatment to the sheath so filled;
the element or target comprising a sheath in which a core is held, the core being formed from a matrix comprising aluminium and silicon within which particles are dispersed, the particles comprising a nucleus, the nucleus consisting of an alloy comprising uranium and molybdenum in γ-metastable phase and being covered by a layer comprising uranium, molybdenum, aluminium and silicon, the layer being positioned in contact with said nucleus and having an atomic silicon content at least equal to 50% at the contact with said nucleus, and wherein the layer is covered with an alumina layer.
